(19) United States
(12) Patent Application Publication
(10) Pub. No.: US 2008/0179788 A1
(43) Pub. Date: Jul. 31, 2008

(54) Method of Forming a Briquette

(76) Inventors: Mitsuma Matsuda, Osaka (JP); Masafumi Sedou, Hyogo (JP)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/055,815

(22) Filed: Mar. 26, 2008

Related U.S. Application Data
(62) Division of application No. 10/503,158, filed on Mar. 31, 2005.

(30) Foreign Application Priority Data
Jan. 31, 2002 (JP) 23804/2002

(51) Int. Cl. B29C 43/02

(52) U.S. Cl. 264/319

(57) ABSTRACT

A brittle molded body (Z) obtained by compression molding into a prescribed shape a flocculent agglomerate (C) comprising ferrous metal shavings and a grinding liquid containing oil and water, the brittle molded body (Z) having a bulk specific gravity of at least 1.5. On the surface side of the brittle molded body (Z) is formed a strengthened layer (K) of higher density and higher hardness than on the inner side. A strengthened briquette (B) is obtained by impregnating a solidification aid D into this brittle molded body (Z).

### TECHNICAL FIELD

The present invention relates to a brittle molded body that enables ferrous metal shavings to be used effectively, and a briquette using the brittle molded body.

### BACKGROUND ART

Shavings produced when grinding (hereinafter this term is used as a concept including polishing, super finishing polishing, lapping and so on) a ferrous metal such as quenched bearing steel or carburized steel are recovered as a flocculent (fibrous) agglomerate containing abrasive grains, a grinding liquid containing water and oil, and so on. Such a flocculent agglomerate contains a large amount of pure iron, and attempts have been made to reuse this as a steel-making raw material. However, the flocculent agglomerate contains a large amount of water, and hence if the flocculent agglomerate is put into a blast furnace as is, then due to the water a problem of bumping (steam explosion) occurring will be brought about. One can thus envisage removing the water from out of the flocculent agglomerate by centrifugation or the like. In this case, the oil contained in the flocculent agglomerate will be removed together with the water, and hence the pure iron that is a component of the shavings will be changed into iron oxide due to self heating of the flocculent agglomerate. In this case, reduction is thus necessary to enable reuse as a steel-making raw material, and the cost increases due to the use of a reducing agent and so on.

Moreover, shavings having the above-mentioned oil attached thereto do not readily stick together, and hence if a flocculent agglomerate is compression molded as is then it will be difficult to solidify the flocculent agglomerate to the desired strength. Furthermore, for a flocculent agglomerate containing a large amount of ferrous metal shavings having a carbon content of at least 0.2 wt %, there will be much spring-back upon compression, and hence even if such a flocculent agglomerate is compression molded it will be difficult to solidify the flocculent agglomerate to the desired strength. Consequently, if the compression molded flocculent agglomerate is put into a blast furnace, then a problem will arise in that the flocculent agglomerate will fly up and scatter around, and hence the majority will be collected by a dust collector.

Furthermore, pulverization of the fibrous shavings contained in a flocculent agglomerate as described above is difficult using a hammer mill or the like, and hence the flocculent agglomerate cannot be finely sheared. It is thus also difficult to process such a flocculent agglomerate into briquettes or the like.

The actual state of affairs is thus that a flocculent agglomerate as described above is not reused, but rather is consigned to a waste disposal company and disposed of as landfill.

However, such disposal of the flocculent agglomerate as landfill is undesirable from the viewpoint of the effective utilization of resources. Moreover, there are problems of deterioration of the environment being brought about, and the disposal cost being high.

The present invention was accomplished in view of the problems described above; it is an object of the present invention to provide a brittle molded body that enables shavings to be reused effectively, and a briquette using the brittle molded body.

### DISCLOSURE OF THE INVENTION

A brittle molded body of the present invention for attaining the above object is a brittle molded body obtained by compression molding into a prescribed shape a flocculent agglomerate comprising ferrous metal shavings and a grinding liquid containing oil and water, and is characterized in that the bulk specific gravity is at least 1.5, and on the surface side is formed a strengthened layer of higher density and higher hardness than on the inner side (claim 1).

With the brittle molded body having this constitution, because the bulk specific gravity is at least 1.5, and moreover a strengthened layer is formed on the surface side, the desired strength and shape maintainability can be secured. Handling such as transportation is thus easy. Moreover, because a large amount of pure iron is contained, for example reuse as a material for a high-quality steel-making raw material briquette or a material for sintered metal is possible, and hence the brittle molded body is useful in environmental conservation, and moreover the disposal cost for shavings can be reduced. Furthermore, because the brittle molded body is a porous body having a bulk specific gravity of at least 1.5, a solidification aid can easily be made to penetrate deep thereinside. The inside of the brittle molded body can thus also be easily strengthened. Note that the lower the bulk specific gravity (i.e. even lower than 1.5), the more easily the solidification aid can be made to penetrate deep thereinside, but on the other hand it will become difficult to secure the desired strength.

The above-mentioned flocculent agglomerate may be one obtained by mixing a flocculent agglomerate containing quenched ferrous metal shavings with a flocculent agglomerate containing unquenched ferrous metal shavings (claim 2). In this case, due to the unquenched ferrous metal shavings, the flocculent agglomerate containing quenched ferrous metal shavings can easily be solidified. Moreover, the bulk specific gravity and the strength of the brittle molded body can be further increased. Furthermore, in this case, it is preferable for the flocculent agglomerate containing unquenched ferrous metal shavings to be mixed in an amount of 30 to 50 wt % (claim 3), whereby the bulk specific gravity and the strength of the brittle molded body can be increased yet more effectively.

The brittle molded body preferably has an oil content of 1 to 12 wt % (claim 4); in this case, the brittle molded body will be solidified to a suitable hardness, and moreover oxidation of pure iron that is a component of the shavings can be prevented effectively by the small amount of residual oil.

The ferrous metal may be one containing at least 0.2 wt % of carbon (claim 5); even with shavings of such a ferrous metal having much spring-back, the shavings are sheared effectively through the compression molding, and hence the brittle molded body can be firmly solidified.

Moreover, a briquette of the present invention is a dried briquette comprising powdered pure iron and oil, and is characterized by being obtained by strengthening the brittle molded body according to any of claims 1 through 5 with a solidification aid impregnated thereinside (claim 6).

With the briquette having this constitution, because the brittle molded body is further strengthened with a solidification aid, the briquette becomes strong, with breakage not being prone to occur, and hence handling during transportation, storage and so on is easy. In particular, because the bulk specific gravity of the brittle molded body is at least 1.5, and a strengthened layer is formed on the surface side of the brittle molded body, the briquette becomes yet stronger, with breakage being yet less prone to occur. Moreover, because the solidification aid can be made to penetrate deep inside the brittle molded body, the strength of the inside of the briquette can also be increased effectively. Furthermore, because the briquette is a dried solid, even if put, for example, into a blast furnace, there will be no risk of bumping occurring or of matter flying up. Moreover, because the briquette contains oil, oxidation of the powdered pure iron is prevented. The briquette can thus be suitably used as a steel raw material briquette in particular.

The solidification aid is preferably at least one selected from colloidal silica, sodium silicate, aluminum phosphate, and emulsified asphalt (claim 7). As a result, an effectively strengthened briquette can be obtained despite containing oil. Therefore, handling during transportation, storage and so on thus becomes yet easier.

The briquette preferably contains 2 to 30 wt % of the solidification aid (claim 8). As a result, a yet more effectively strengthened briquette can be obtained.

### BRIEF DESCRIPTION OF THE DRAWINGS

FIG. 1 is a perspective view showing a brittle molded body according to an embodiment of the present invention.

FIG. 2 is a schematic view showing a cross section of the brittle molded body.

FIG. 3 is a graph showing the compressive fracture strength of brittle molded bodies.

FIG. 4 is a process drawing showing a method of manufacturing a brittle molded body and a briquette.

### BEST MODE FOR CARRYING OUT THE INVENTION

Following is a detailed description of embodiments of the present invention, with reference to the attached drawings.

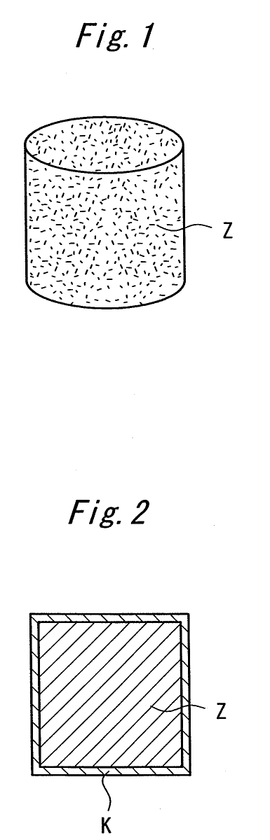

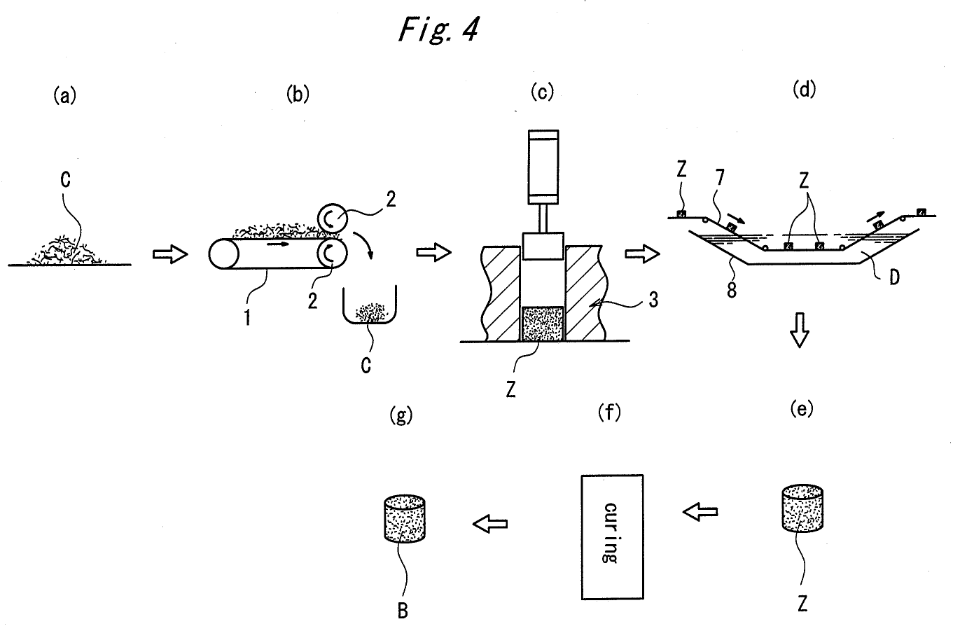

FIG. 1 is a perspective view showing a brittle molded body Z according to an embodiment of the present invention. The brittle molded body Z is obtained by solidifying by compression molding into a cylindrical shape a flocculent agglomerate C (see FIG. 4) comprising a grinding liquid containing oil and water and shavings produced when grinding a quenched ferrous metal.

The brittle molded body Z is compression molded such that the bulk specific gravity thereof becomes at least 1.5; as a result, the fibrous shavings are sheared, and a porous brittle body having a suitable amount of oil and voids is formed. Moreover, the oil content of the brittle molded body Z is adjusted to 1 to 12 wt %.

Furthermore, on the surface side of the brittle molded body Z is formed a strengthened layer K of higher density and higher hardness than on the inner side (see FIG. 2). In the case, for example, that the brittle molded body Z is a cylindrical shape with a diameter of 60 to 70 mm and a height of 30 to 40 mm, this strengthened layer K is formed over a region up to a depth of 0.3 to 7.0 mm from the surface; the durometer hardness A in the strengthened layer K is at least 90, and is at least 10 to 30 harder than the durometer hardness A around the central part, and the bulk specific gravity is at least 0.5 to 1 higher than the bulk specific gravity around the central part.

With the brittle molded body Z, oxidation of pure iron that is a component of the shavings is prevented by the residual oil. Moreover, because the bulk specific gravity is at least 1.5 and a strengthened layer K is formed on the surface side, the desired strength and shape maintainability can be secured. Disintegration is thus not prone to occurring when handling during transportation and the like. Furthermore, because the oil content of the brittle molded body Z is 1 to 12 wt %, the brittle molded body Z is solidified to a suitable hardness, and moreover oxidation of the pure iron that is a component of the shavings is prevented effectively by the small amount of residual oil.

As the above-mentioned ferrous metal, one containing at least 0.2 wt % of carbon may be used. Shavings of such a ferrous metal have much spring-back, and hence solidification is difficult, but by using compression molding, the influence of spring-back can be eliminated, and the shavings can be sheared effectively, and hence solidification becomes possible. A representative example of the shavings containing at least 0.2 wt % of carbon is bearing steel shavings.

The brittle molded body Z can be suitably used as, for example, a steel raw material briquette B (see FIG. 4(g)) by impregnating a solidification aid D into the brittle molded body Z to strengthen the brittle molded body Z. As the solidification aid D, it is preferable to use at least one selected from colloidal silica, sodium silicate, aluminum phosphate, and emulsified asphalt, whereby the briquette B can be made stronger despite containing oil. Moreover, the content of the solidification aid D is preferably 2 to 30 wt %, whereby the briquette B can be made yet stronger. Note that vinyl acetate or the like can also be used as the solidification aid D.

With the briquette B, because the brittle molded body Z is further strengthened with the solidification aid D, the briquette B becomes strong, with breakage being less prone to occur when handling during transportation, storage and so on. In particular, because the bulk specific gravity of the brittle molded body Z is at least 1.5, and the strengthened layer K part on the surface side of the brittle molded body Z is effectively solidified by the solidification aid D, the briquette B becomes yet stronger, with breakage being yet less prone to occur. Moreover, because the brittle molded body Z is a porous body having a bulk specific gravity of at least 1.5, and hence the solidification aid D can be made to penetrate deep thereinside with no impediment, the strength of the inside of the briquette B can also be increased effectively. As a result, even if breakage should occur, there will be no risk of the inside part scattering into a powder. Moreover, the briquette B is a dried solid, and hence even if put, for example, into a blast furnace, there will be no risk of bumping occurring or of matter flying up. Furthermore, because the briquette B contains oil, oxidation of the powdered pure iron is prevented. The briquette B is thus particularly suitable as a steel-making raw material briquette.

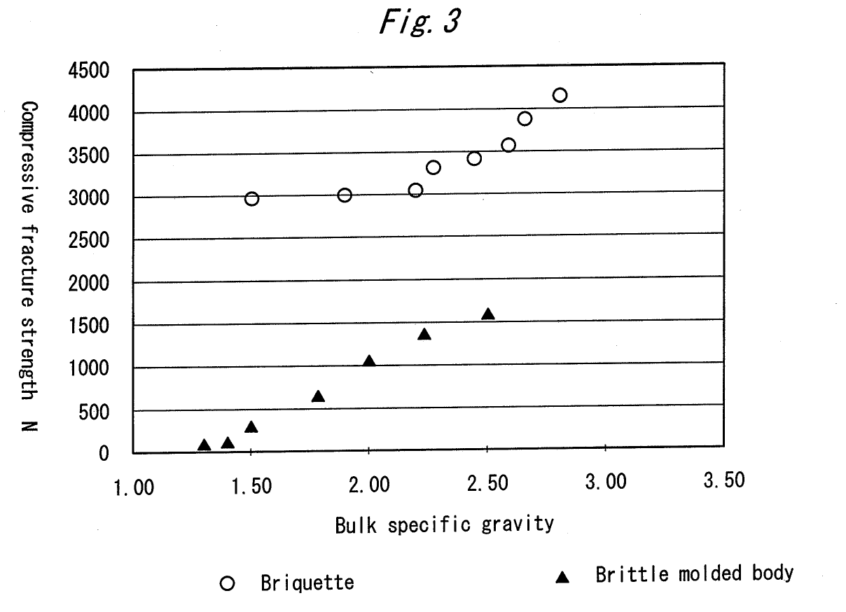

FIG. 3 is a graph showing the results of carrying out compressive fracture tests on brittle molded bodies and briquettes having different specific gravities. The brittle molded bodies and briquettes used in these compressive fracture tests had a cylindrical shape with an outside diameter of 6.6 cm and a width of 3.5 cm, and the bulk specific gravity was in a range of 1.3 to 2.5 for the brittle molded bodies, and 1.5 to 2.8 for the briquettes. Moreover, the brittle molded bodies were manufactured using flocculent agglomerates obtained by grinding a quenched ferrous metal. The solidification aid impregnated into the brittle molded bodies to obtain the briquettes was an aqueous solution containing approximately 10 wt % of sodium silicate, and this aqueous solution was impregnated into each brittle molded body in an amount of approximately 20% of the volume of the brittle molded body. For the compressive fracture tests, pressure was applied in the radial direction to two opposite points on the outer periphery, and the load upon fracture was measured. The loading rate was set to 1 mm/min.

As is clear from FIG. 3, it was found that the compressive fracture load for brittle molded bodies having a bulk specific gravity of less than 1.5 is less than 150 N and hence these brittle molded bodies are very brittle, whereas the compressive fracture load for brittle molded bodies having a bulk specific gravity of at least 1.5 is in a range of 240 N to 1600 N, i.e. fracture does not readily occur. Moreover, it was found that the fracture strength for the briquettes is 2900 to 4200 N, i.e. a good strength can be secured. In particular, the compressive fracture load required of a steel-making briquette is approximately 2000 N or more, and it was found that this compressive fracture load can be sufficiently secured.

Note that for a flocculent agglomerate C produced when grinding a quenched ferrous metal, depending on the material thereof compression molding may be difficult, but in this case by mixing the flocculent agglomerate C with a flocculent agglomerate C produced when grinding an unquenched ferrous metal, compression molding can be carried out easily and a strong molded body can be obtained. The flocculent agglomerate C of the unquenched ferrous metal is preferably mixed in an amount of 30 to 50 wt %, whereby a very high-density high-strength brittle molded body Z having a bulk specific gravity of 3.0 to 4.5 and a fracture strength of 2000 to 3000 N can be obtained. Moreover, by impregnating a solidification aid D into this brittle molded body Z, a briquette B having a fracture strength of at least 3100 N can be obtained.

FIG. 4 is a process drawing showing an example of a method of manufacturing a brittle molded body Z and a briquette B as described above. In the manufacture of the brittle molded body Z, first a flocculent agglomerate C of shavings (see FIG. 4(a)) is compressed through application of pressure, thus preliminarily adjusting the contents of water and oil that are components of the grinding liquid contained in the flocculent agglomerate C. The compression of the flocculent agglomerate C through application of pressure is carried out, for example, by conveying the flocculent agglomerate C along a belt conveyor 1 and passing the flocculent agglomerate C between a pair of rollers 2 (see FIG. 4(b)). Note, however, that for the adjustment of the water content and oil content, there are also a method in which this is carried out merely through air blowing or air compression, and a method in which a magnetic separator is used. Here, it is preferable to adjust the water content of the flocculent agglomerate C to a range not exceeding 50 wt %, and the oil content to a range not exceeding 50 wt %. As a result, handling such as transportation and storage of the flocculent agglomerate C becomes easy.

Next, the flocculent agglomerate C for which the water content and the oil content have been adjusted is subjected to compression molding using a molding die 3, e.g. a hydraulic press, thus obtaining a brittle molded body Z (see FIG. 4(c)). Here, the flocculent agglomerate C is compressed such that the bulk specific gravity of the brittle molded body Z becomes at least 1.5. Through the compression molding, spiral fibrous shavings contained in the flocculent agglomerate C are sheared, and moreover a strengthened layer K is formed on the surface side. Moreover, the rate of compression of the flocculent agglomerate C, the water drainage amount and the oil drainage amount during the compression and so on are controlled such that the water content becomes 2 to 12 wt %, and the oil content becomes 1 to 12 wt %. At this time, because the water content and the oil content of the flocculent agglomerate C were each adjusted in advance to a range not exceeding 50 wt % in the previous step, the water content and the oil content in the brittle molded body Z can be adjusted easily and properly.

Next, a liquid solidification aid D is impregnated into the brittle molded body Z. The impregnation of the solidification aid D is carried out, for example, by conveying the brittle molded body Z along a belt conveyor 7 and immersing the brittle molded body Z in the solidification aid D which has been poured into a tank 8 (see FIG. 4(d)).

After that, the brittle molded body Z that has been impregnated with the solidification aid D (see FIG. 4(e)) is cured (dried) (see FIG. 4(f)), whereby a briquette B can be obtained (see FIG. 4(g)). Through the curing, excess solidification aid D that has penetrated to the inside of the brittle molded body Z moves to the surface side, and some of the solidification aid D evaporates, and the remainder remains in the high-density strengthened layer K part, and hence the strengthened layer K part is effectively strengthened.

The brittle molded body Z obtained as described above always retains some of the oil of the grinding liquid including during the processing, and hence oxidation of pure iron that is a component of the shavings is prevented effectively. Moreover, the briquette B is manufactured with some of the oil of the grinding liquid always retained, and hence oxidation of the pure iron is prevented effectively. For example, it was found that a briquette B manufactured using a flocculent agglomerate C containing bearing steel (SUJ-2) shavings contains at least 70 wt % of pure iron. The melting yield is thus very high at least 70%, and hence the briquettes B can be sold to a steel maker as a high-quality steel-making raw material.

Moreover, with the method of manufacturing the briquette B described above, the flocculent agglomerate C can be solidified without a step of finely pulverizing the flocculent agglomerate C being required, and hence the briquette B can be manufactured efficiently.

Note that when the solidification aid D is impregnated into the brittle molded body Z, the solidification aid D may be diluted with water, a solvent or the like; in this case, the solidification aid D can be made to penetrate deep into the brittle molded body Z more easily and swiftly, and moreover for a solidification aid D containing silicon such as sodium silicate, the amount of silicon can be reduced through the dilution, and hence the amount of impurities is further reduced, which is more preferable as a steel-making raw material.

Moreover, the brittle molded body Z is formed in a shape for which handling is easy, for example the cylindrical shape described above, or a spherical shape, a prismatic shape or the like.

Furthermore, the brittle molded body Z of the present invention may be finely pulverized, whereby instead of reuse as a steel-making raw material briquette B as described above, reuse is possible as a powdered raw material for sintered metal, or an additive in a resin or the like for a magnetic material.

1-8. (canceled)

9. A method of forming a briquette comprising the following steps of:
compression molding a fibrous agglomerate comprising ferrous metal shavings and a grinding liquid containing oil and water, to form a porous brittle molded body having a surface side and an inner side, and having a bulk specific gravity of not less than 1.5,
impregnating the obtained brittle molded body with a solidification assistant, and
drying the brittle molded body impregnated with the solidification assistant, whereby the surface side of the brittle molded body has a strengthened layer which is of higher density and higher hardness than the inner side of the brittle molded body and having a bulk specific gravity that is at least 0.5 higher than the bulk specific gravity of the inner side.

10. The method according to claim 9, wherein the fibrous agglomerate is obtained by mixing a fibrous agglomerate containing quenched ferrous metal shavings with a fibrous agglomerate containing unquenched ferrous metal shavings.

11. The method according to claim 10, wherein 30 to 50 wt % of the fibrous agglomerate containing unquenched ferrous metal shavings is mixed in.

12. The method according to claim 9, wherein the brittle molded body has an oil content of 1 to 12 wt %.

13. The method according to claim 9, wherein the ferrous metal contains at least 0.2 wt % of carbon.

14. The method according to claim 9, wherein the solidification aid is at least one selected from colloidal silica, sodium silicate, aluminum phosphate, and emulsified asphalt.

15. The method according to claim 9 wherein the briquette contains 2 to 30 wt % of the solidification aid.
